(19) United States
(12) Patent Application Publication
(10) Pub. No.: US 2003/0021982 A1
(43) Pub. Date: Jan. 30, 2003

(54) Preparation of graded semiconductor films by the layer-by-layer assembly of nanoparticles

(76) Inventor: Nicholas A. Kotov, Stillwater, OK (US)

Correspondence Address: FELLERS SNIDER BLANKENSHIP, BAILEY & TIPPENS, THE KENNEDY BUILDING, 321 SOUTH BOSTON SUITE 800, TULSA, OK, 74103-3318, US

(21) Appl. No.: 10/179,999

(22) Filed: Jun. 25, 2002

Related U.S. Application Data
(60) Provisional application No. 60/301,113, filed on Jun. 25, 2001.

(51) Int. Cl. B32B 15/04

(52) U.S. Cl. 428/323; 428/328; 428/331; 428/640; 428/469

(57) ABSTRACT

This invention relates to the layer-by-layer assembly of graded semiconducting films by laying nanoparticles on a substrate in a sequence from smaller to larger sizes, which can be done economically and effectively. Layer-by-layer assembly (LBL) enables effective processing of semiconductor, metal, or metal oxide nanoparticle dispersions into functional advanced materials, which retain distinctive optical, magnetic and electrical qualities of size-quantized state of matter.

### RELATED APPLICATIONS

This application claims priority from provisional U.S. patent application Serial No. 60/301,113 filed on Jun. 25, 2001, the disclosure of which is incorporated herein by reference.

### STATEMENT REGARDING FEDERALLY SPONSORED RESEARCH

The development of the subject matter of this application was partially supported by a grant from the National Science Foundation (NSF-CHE-9876265). Accordingly, the U.S. government may have rights in this invention.

### BACKGROUND OF THE INVENTION

1. Field of the Invention

This invention relates generally to thin films of inorganic nanoparticles.

2. Background of the Invention

Thin film technology, wherein inorganic particles with sizes on the order of 1-10 nm are arranged in layers to form a film, is being used presently for an increasingly large number of different technological applications, including, among other things, information storage devices, chemical and biological sensors, fiber-optical systems, magneto-optical and optical devices, protective coatings and light emitting diodes. Current techniques for preparing such films include chemical vapor deposition (in which no discrete inorganic particles are involved), sol-gel technology (producing porous materials that can be sintered to get uniform films), or deposition from colloidal dispersions (spin-coating, dip-coating, Langmuir-Blodgett depositions, etc.).

Layer-by-layer assembly of thin films of nanoparticles is disclosed in my co-pending U.S. patent application Ser. No. 09/492,951, incorporated herein by reference. Layer-by-layer deposition of nanoparticles offers important advantages over the above since it can be performed under ambient conditions and can be easily implemented for automated processes. The driving force for layer-by-layer assembly (LBL) is the electrostatic attraction of positive and negative charges situated on the surface of inorganic colloids and polyelectrolytes. Inorganic particles of various nature (magnetic, metallic, semiconducting, etc.) in which the individual surface is homogeneously coated with a different organic or high molecular weight organic material, are utilized for the preparation of mono- and multi-layers, by means of the layer-by-layer assembly process upon various kinds of substrates. A need exists, however, in the preparation of graded thin film nanoparticles, particularly in the manufacture of semiconducting coatings.

### SUMMARY OF THE INVENTION

This invention relates to the layer-by-layer assembly of graded semiconducting films by laying nanoparticles on a substrate in a sequence from smaller to larger sizes. Layer-by-layer assembly is discussed in an article by Decher, G. Science 1997, 277, 1232-1237; Decher, G.; Hong, J. D. Ber.Bunsen-Ges.Phys.Chem. 1991, 95, 1430-1434, which is incorporated herein by reference. Layer-by-layer assembly (LBL) enables effective processing of semiconductor, metal, or metal oxide nanoparticle dispersions into functional advanced materials, which retain distinctive optical, magnetic and electrical qualities of size-quantized state of matter.

In an optimized LBL deposition, when the UV-vis absorption density linearly increases with the number of deposition cycles, the packing and thickness of nanoparticles is reproduced from layer to layer. After coating with polyelectrolyte, the nanoparticles become virtually immobile in the densely packed multilayer stack, which prevents phase separation of the nanoparticles/polymer mixture even at the nanoscale. This leads to materials with much better homogeneity (especially for high nanoparticle loadings) than spin-coated or painted nanoparticle/polymer mixtures, which is important for many optical and electronic devices.

In addition to the above, tight packing of nanoparticles also makes possible the design of materials with intentional inhomogeneity by depositing LBL bilayers in a certain sequence. This invention demonstrates the possibility of the LBL production of one-dimensionally graded semiconducting materials. The latter demonstrate unique capabilities as photo detectors, bipolar transistors, waveguides, light-emitting, non-linear optical, magneto optical, and high-speed devices. This type of material also reveals new phenomena in charge injection, charge carrier dynamics, and light trapping. However, graded semiconductors are difficult to make, and typically high capital investment techniques such as molecular beam epitaxy and plasma enhanced chemical vapor deposition are required for their preparation.

Accordingly, an object of the present invention is to build a graded semiconducting material by laying nanoparticles on a substrate in a sequence, which can be done simply, economically and effectively.

A further object of the present invention is to lay the nanoparticles in a sequence from smaller to larger.

A still further object of the present invention is to coat the graded semiconducting material in order to tightly pack the nanoparticles.

An additional object of the present invention is to create layer-by-layer bilayers of graded nanoparticles.

A better understanding of the present invention, its several aspects, and its objects and advantages will become apparent to those skilled in the art from the following detailed description, taken in conjunction with the attached drawings, wherein there is shown and described the preferred embodiment of the invention, simply by way of illustration of the best mode contemplated for carrying out the invention.

### BRIEF DESCRIPTION OF THE DRAWINGS

FIG. 1 is a schematic representation of (a) cross-section and (b) band energies in the graded semiconducting material from nanoparticles.

FIG. 2 includes luminescence spectra of (a) exemplary CdTe nanoparticles of the present invention, and (b) thin films obtained after the sequential deposition of 5 bilayers of (1) “green”, (2) “yellow” (3) “orange”, and (4) “red” CdTe.

FIG. 3 includes transmission electron microscopy images of the graded film cross-sections made from 5 bilayers of “green”, “yellow”, and “red (total 15): nanoparticles. (a) and (b) are survey images; (c) and (d) are close-up images of the center section and “red” side of the nanoparticles film.

FIG. 4 is a cross-sectional confocal microscopy image of the graded LBL film of CdTe nanoparticles made of 10 bilayers of “green”, yellow”, “orange”, and “red” nanoparticles (total 40).

### DETAILED DESCRIPTION OF THE PREFERRED EMBODIMENT

Layer-by-layer assembly (LBL) enables effective processing of semiconductor, metal, or metal oxide nanoparticle dispersions into functional advanced materials, which retain distinctive optical, magnetic and electrical qualities of size-quantized state of matter.

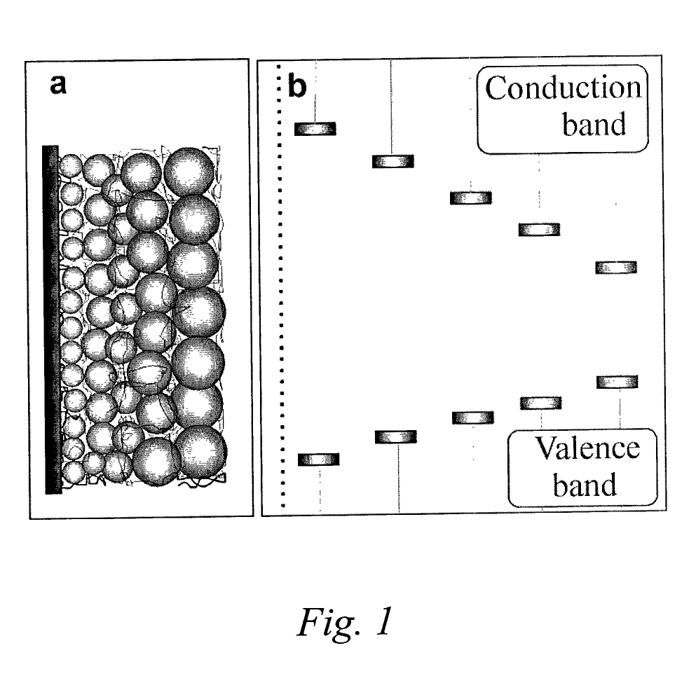

As described above, by using the LBL assembly of nanoparticles a graded semiconducting material may be built by laying nanoparticles on a substrate in a sequence from smaller to bigger nanoparticles, which can be done economically and effectively. Due to the strong size dependence of the nanoparticles conduction and valence band energies, their arrangement by particle diameters results in a gradual change of the band gap as pictured in FIG. 1, and therefore, creates an intrinsic ramp of hole and electron potential.

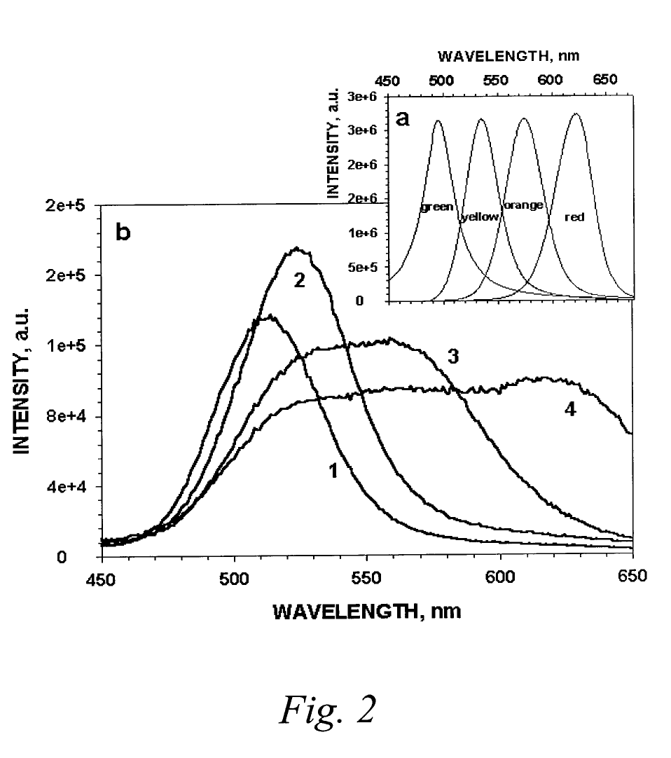

The model graded films can be prepared from highly luminescent CdTe nanoparticles (quantum yield 15-20%) stabilized by thioglycolic acid. CdTe nanocrystals of different diameters are synthesized according to the procedure described below in a publication by Rogach, A. L.; Katsikas, L.; Komowski, A.; Su, D. S.; Eychmuller, A.; Weller, H. Ber.Bunsen-Ges.Phys.Chem.Chem. 1996, 100, 1772-1778 (incorporated herein by reference). The graded nanoparticle films are assembled by using four different CdTe dispersions with luminescence maxima at 495-505, 530-545, 570-585, and 605-620 nm which display respectively green, yellow, orange and red luminescence (FIG. 2a) and which will be referred to accordingly. Layer-by-layer assembly is carried out on glass and plastic substrates and in this preferred embodiment, 5-10 CdTe nanoparticle bilayers of each of four luminescent colors are deposited. It should be noted that high luminescence quantum yield is not a rigid requirement for this preferred embodiment, however it is a useful property that enables convenient probing of the film structure.

The layer-by-layer assembly of CdTe nanoparticles shall next be described. Thorough rinsing of the sample with deionized water should preferably precede the deposition of nanoparticles and polyelectrolytes. Preferably, the LBL deposition starts from placing a glass slide into a 0.5% wt. solution of PDDA poly (dimethyldiallylammonium) (pH 9.0) for ten (10) minutes, followed by rinsing with deionized water and immersion into a 0.5% wt. solution of PAA (pH 4.0) for ten (10) minutes. The PDDA/PAA ground layer is thus formed, which renders the substrate surface more uniform, thereby providing better adsorption of subsequent nanoparticle layers. Subsequent to the deposition of a new PDDA layer, the substrate is exposed to as-synthesized CdTe dispersion (pH 9-10). After approximately twenty (20) minutes of Np adsorption, the substrate is removed and rinsed. The PDDA and nanoparticle adsorption steps are repeated until the desired number of bilayers are deposited. In the preferred process, the solution is then exchanged for one with nanoparticles of different size and the above-described procedure is repeated.

The assembly starts from the smallest nanoparticles (“green”) and proceeds to the biggest ones (“red”) according to the visible light spectral sequence. With addition of the layers of increasing diameter, the luminescence of the assembly shifts toward the red part of the spectrum while also becoming broader (FIG. 2b). Finally, the luminescence spectrum of the stack of all four nanoparticle diameters has a plateau appearance reflecting almost equal emission intensity in a wide range of wavelengths. As compared to the original spectra of CdTe nanoparticles, some prevalence of the red emission (red shift) should be attributed to the excitation energy transfer from smaller nanoparticles to bigger ones.

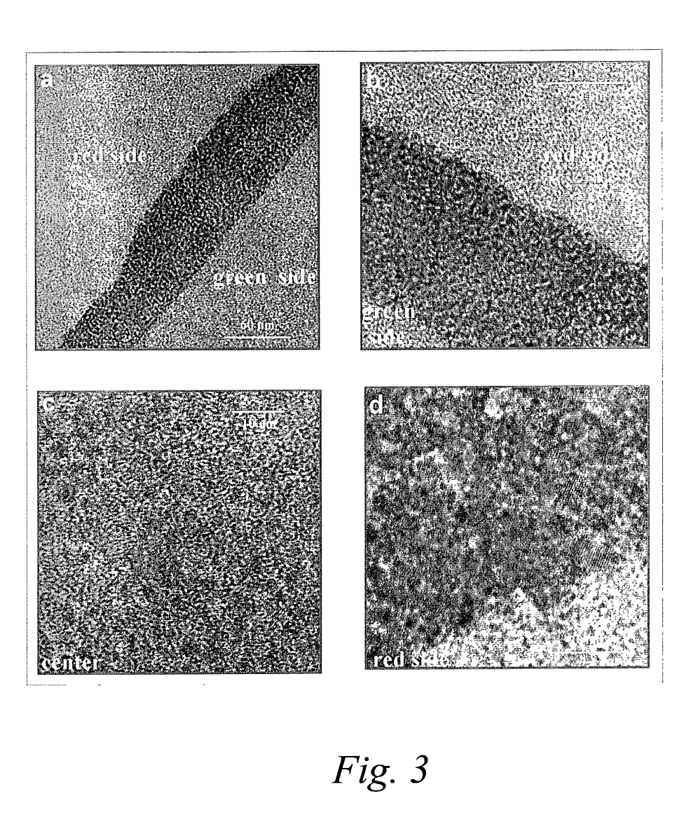

In order to evaluate the internal structure of the gradient CdTe film, it may be assembled on a flexible cellulose acetate substrate as described in a publication by Mamedov, A.; Ostrander, J.; Aliev, F.; Kotov, N. A. Langmuir 2000, 16, 3941-3949; Mamedov, A. A.; Kotov, N. A. Langmuir 2000, 16, 5530-5533. A cross-sectional slice of the nanoparticle stack may be analyzed by transmission electron microscopy (TEM). The asymmetry of the film can be seen in the difference of electron diffracting power of the “red” and “green” sides of the assembly as depicted in FIG. 3a and b. As shown, the layers of bigger nanoparticles appear noticeably darker in the TEM image due to the greater percentage of heavier elements on this side of the multilayer stack (FIG. 3a,b).

Although it is quite difficult to obtain the images of single nanoparticles in the network of the polyelectrolyte matrix, the areas of crystallinity that can be identified with the diameter of the particles can be observed to be different in the corresponding parts of the gradient film being 2-3 nm in the “green” and “yellow” parts and 5-6 nm on the “red” side of the assembly. This correlates well with the particle size expected from the emission wavelength as shown in FIG. 2a.

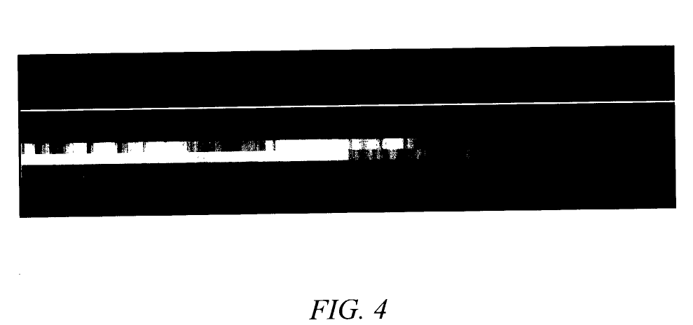

The gradient nature of the prepared nanoparticle film can be unequivocally established by confocal optical microscopy. The sample is assembled as described above on a glass slide and the series of luminescence images can be obtained at a different focus depth inside the assembly. In the preferred embodiment, the images are processed by Leica TCS NT confocal microscope software and a cross-sectional image without physical sectioning of the film may be obtained. This image is shown in FIG. 4. As can be seen, the image clearly shows the gradual change of the luminescence emission wavelength from green in the bottom to red on the top of the stack. Small nanoparticles are assembled in the lower part (green and yellow luminescence), while bigger nanoparticles are assembled on top of them (orange and red luminescence). Total thickness of the film was estimated to be 220+/−20 nm by the same technique. The gradual change also indicates the concomitant increase of the nanoparticle diameters, and therefore, confirms the arrangement of the valence and conduction band energies as described above in reference to FIG. 1.

Looking at the perspectives of the graded semiconductor films made of nanoparticles, one can expect significant interest in this type of material for use in photonic devices. The combination of size quantization and gradient nature of the material opens a possibility for new optical and electrical effects as well as for the optimization of existing applications of nanoparticle thin films based on charge transfer from particle to particle as well as from particle to electrode. For the latter, the benefits of the graded media can be demonstrated by the markedly better light emitting performance when the homogeneous media in polymer light-emitting diodes is replaced with graded media. Additionally, the nanoparticle layers can be organized on a scale smaller than the wavelength of visible light, and therefore, one can engineer polarizability, refractive index and other parameters on the molecular level in such assemblies, so that the overall interaction of electromagnetic waves with the film will be significantly different than in the traditional optically uniform material.

It should be understood herein that the layer sequence has been used here as a parameter controlling the properties of the LBL assemblies. Although being simple in concept, one-dimensional ordering of nanoparticles assemblies, which produce a gradual, abrupt or any other programmed change in properties, can be a powerful tool for optimizing diverse functional properties of nanostructured materials from biological, e.g., designing an artificial leaf, to electronic.

It should also be understood that while the invention has been described with a certain degree of particularity, it is manifest that many changes may be made in the details of the process of assembly without departing from the spirit and scope of this disclosure. It is understood that the invention is not limited to the preferred embodiments and experimental methods set forth herein for the purpose of exemplification, but is to be limited only by the scope of the attached claim or claims, including the full range of equivalency to which each element or step thereof is entitled.

In the claims:

1. A nanoparticle film comprising:
a first nanoparticle dispersion having a first luminescent maxima;
a second nanoparticle dispersion having a second luminescent maxima, wherein said second luminescent maxima is has a greater wavelength than said first luminescent maxima; and
wherein said first nanoparticle dispersion and said second nanoparticle dispersion form a graded media.

2. The film according to claim 1 wherein:
said nanoparticles are comprised of CdTe.

3. The film according to claim 1 wherein:
said first luminescent maxima is between approximately 496 and 505 nm; and
said second luminescent maxima is between approximately 530 and 545 nm.

4. The film according to claim 1 further comprising:
a third nanoparticle dispersion having a luminescent maxima of a greater wavelength than said second luminescent maxima.

5. The film according to claim 4 wherein:
said third nanoparticle dispersion has a luminescent maxima of between approximately 530-545 nm.

6. The film according to claim 4 wherein:
said third nanoparticle dispersion displays an orange luminescence.

7. The film according to claim 4 further comprising:
a fourth nanoparticle dispersion having a luminescent maxima of a greater wavelength than said third nanoparticle dispersion.

8. The film according to claim 7 wherein:
said fourth nanoparticle dispersion has a luminescent maxima of between approximately 605 to 620 nm.

9. The film according to claim 7 wherein:
said fourth nanoparticle dispersion has a red luminescence.

10. The film according to claim 1 wherein:
between approximately 5 to 10 nanoparticle bilayers of each of said dispersions comprise said film.

11. A method of layer-by-layer assembly of nanoparticles comprising the steps of:
a. placing a slide into a polyelectrolyte solution;
b. rinsing said slide;
c. immersing said slide into a solution of PAA, thereby forming a polyelectrolyte/PAA substrate layer for rendering a surface of said slide more uniform to provide better adsorption of subsequent nanoparticle layers;
d. exposing said surface of said substrate to a nanoparticle dispersion;
repeating steps a-d until a desired number of nanoparticle bilayers are deposited on said substrate;
exchanging said nanoparticle dispersion for a second nanoparticle dispersion having nanoparticles of a different size; and
repeating above steps as desired.

12. The method according to claim 11 wherein:
said step of placing said slide into a polyelectrolyte solution comprises placing said slide into PDDA.

13. The method according to claim 11 wherein:
said step of exposing said surface of said substrate to a nanoparticle dispersion comprises exposing said surface of said substrate to a CdTe nanoparticle dispersion.

14. The method according to claim 11 wherein:
said step of exchanging said nanoparticle dispersion for a second nanoparticle dispersion having nanoparticles of a different size comprises exchanging said nanoparticle dispersion for a second nanoparticle dispersion having nanoparticles of a larger size, whereby an addition of layers having increasing diameter results in a shift of luminescence of the assembly toward a red part of an optical spectrum.

15. The method according to claim 11 further comprising:
repeating steps a-d until a luminescence spectrum from a stack of four nanoparticle diameters has a plateau appearance reflecting approximately equal emission intensity in a wide range of wavelengths.
